(19) United States
(12) Patent Application Publication
(10) Pub. No.: US 2011/0143742 A1
(43) Pub. Date: Jun. 16, 2011

(54) DIGITAL COMMUNICATION VIA A MOBILE HANDHELD NETWORK DEVICE

(76) Inventors: Jeffrey Gary Halbert, Marathon, FL (US); Robert Moir, IV, Marathon, FL (US)

(21) Appl. No.: 12/636,730

(22) Filed: Dec. 12, 2009

(51) Int. Cl. H04W 40/00

(52) U.S. Cl. 455/422.1

(57) ABSTRACT

A method, device and system for providing digital communication over a network protocol via a cellular broadband device which may include converting voice communication into a first transmission medium and transmitting the same to a server via the internet. Once received at a server, the converted voice communication can be converted into a second transmission medium and transmitted to a recipient. Additionally, a method can include receiving a first transmission medium at a server, accessing a memory containing a static identifier associated with a telephone number, converting the first transmission medium into a second transmission medium and transmitting the second transmission medium to the broadband cellular device. Once received at the device, the received transmission medium can be converted to voice data and presented to a user.

### FIELD OF THE INVENTION

The present invention relates to the field of providing digital communication services via a cellular device.

### BACKGROUND OF THE INVENTION

Recent advances in cellular and broadband technologies are changing the way we communicate with each other. With the introduction of Smartphone technology, cellular users are able to download third party applications, browse the internet, check email and perform instant messaging on their cellular phones with ever increasing speed and ease. As such, cellular carriers constantly strive to increase the bandwidth and reliability of their networks which incorporate both voice and data channels in order to accommodate the influx of new services available to consumers. Moreover, as many cellular providers currently offer fixed rates for unlimited data plans but continue to charge by the minute for voice communication, it would be beneficial to provide a method and system in which voice communication could be conducted across a cellular broadband network without incurring “by the minute” charges for voice communication.

Several patent applications have been directed to cellular and wireless communications including: Bear U.S. Pat. No. 7,440,556; Chiu U.S. Pat. No. 7,546,554; and Hollstrom U.S. Pat. No. 6,968,365, however, none of these address the issues outlined above.

### SUMMARY OF THE INVENTION

The present invention is directed to a method and system for providing digital communication over a network protocol via a cellular broadband device. One embodiment of the present invention can include receiving a voice communication at the cellular broadband device, converting the voice communication into a first transmission medium and transmitting the same to a server via a network. Once received at a server, the converted voice communication can be converted into a second transmission medium and transmitted to a recipient.

Another embodiment of the present invention can include a method for receiving digital communication over a network protocol at a cellular broadband device that includes receiving a first transmission medium at a server, accessing a memory containing a static identifier associated with a telephone number, converting the first transmission medium into a second transmission medium and transmitting the second transmission medium to the broadband cellular device. Once received at the device, the received transmission medium can be converted to voice data and presented to a user. Yet another embodiment of the present invention can include a system for performing the features outlined above.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a broadband cellular device for carrying out the inventive concepts of the present invention.

FIG. 2 is a flow chart illustrating a method for converting voice communication into digital data voice packets for transmission via a broadband cellular network according to one embodiment.

FIG. 3 illustrates a system for transmitting voice data via a broadband cellular network according to one embodiment.

FIG. 4 illustrates a method for identifying a broadband cellular device by a gateway server according to one embodiment.

FIG. 5 illustrates a method for receiving a voice communication over a cellular broadband network according to one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As will be appreciated by one skilled in the art, aspects of the present invention may be embodied as a system, method or computer program product. Accordingly, aspects of the present invention may take the form of an entirely hardware embodiment, or an embodiment combining software (including firmware, resident software, micro-code, etc.) and hardware aspects that may all generally be referred to herein as a “circuit,” “module,” “system,” or “unit.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, cellular, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. More specifically, a computer readable storage medium may be a cellular telephone incorporating an operating system capable of storing and executing program code. These operating systems may include: symbian, Linux, Windows Mobile, Java, Garnet, MAC OS, or any other unique operating system configured to be utilized within a cellular device.

Program code embodied on a computer readable medium may be transmitted using any appropriate medium, including but not limited to wireless (i.e. cellular, and/or broadband data transmission), wireline, optical fiber cable, RF, etc., or any suitable combination of the foregoing. Computer program code for carrying out operations for aspects of the present invention may be written in any combination of one or more programming languages, including Wireless Application Protocol (WAP), an object oriented programming language such as Java, Smalltalk, C++ or the like and conventional procedural programming languages, such as the “C” programming language or similar programming languages. The program code may execute entirely on the user's device/computer, partly on the user's device/computer, as a standalone software package, partly on the user's device/computer and partly on a remote device/computer or entirely on the remote device/computer or server. In the latter scenario, the remote device/computer may be connected to the user's device/computer through any type of network, including a cellular network, cellular broadband network, local area network (LAN) or a wide area network (WAN), or the connection may be made to an external computer (for example, through one of the above mentioned networks to the Internet using an Internet Service Provider). The computer program instructions may also be loaded onto a computer, other programmable data processing apparatus, or other devices to cause a series of operational steps to be performed.

A device method and system are described for providing digital communication over a Network. As used herein, a “Network” can include, for example, a cellular network, a cellular broadband network, a wireless area network (WAN), a local area network (LAN), etc. For purposes of this discussion, a wireless communication network may be a Code Division Multiple Access Network (CDMA) capable of utilizing broadband technology such as Evolution-Data Optimized or Evolution-Data Only (EV-DO).

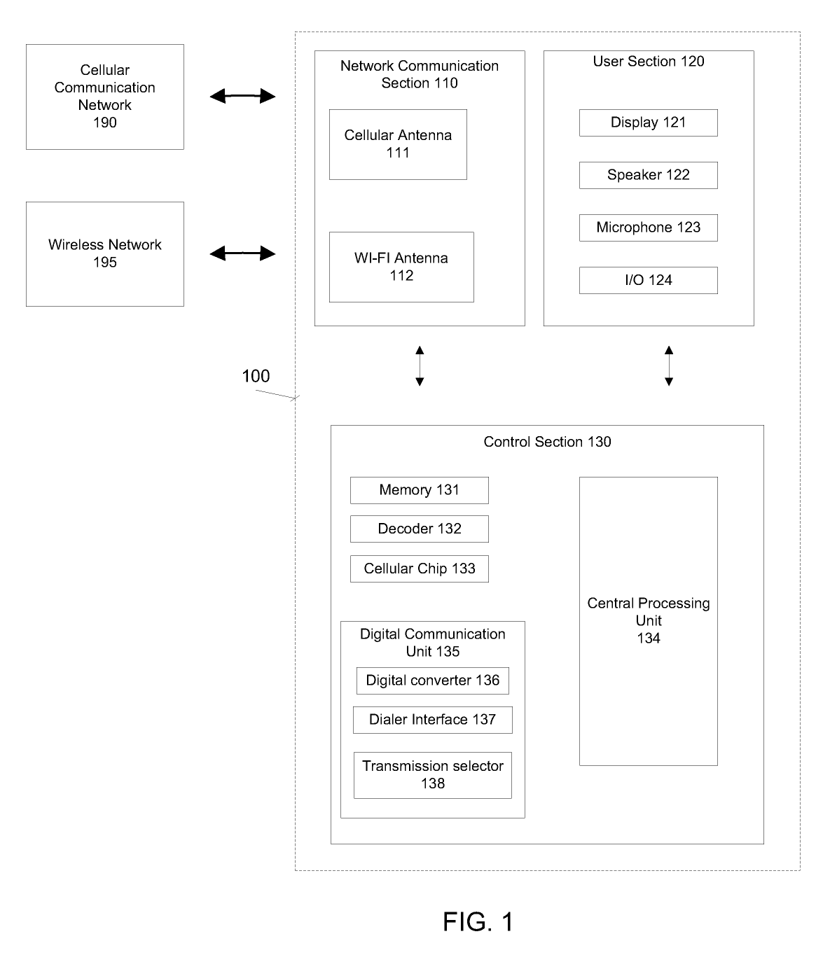

FIG. 1 illustrates one embodiment of a broadband cellular device for carrying out the inventive concepts of the present invention. Specifically, FIG. 1 illustrates a broadband cellular device 100 that includes a Network communication section 110, a user section 120 and a control section 130.

As illustrated in FIG. 1, the communication section 110 can communicate with external elements such as a cellular communication network 190 or a wireless network 195. As such, the communication section 110 can include a cellular antenna 111 and a WI-FI antenna 112. The cellular antenna 111 can transmit and receive information across both the voice channels and data channels of a cellular network 190. As used herein, the data channels of a cellular network may also be referred to as broadband, a broadband network or a broadband cellular network. The WI-FI antenna 112 can connect to the internet via a wireless network 195.

The user section 120 employs commonly known elements which enable a user of the device 100 to utilize the inventive features described herein. To this end, the user section may include a display 121, a speaker 122, a microphone 123 and an input-output device 124. As known to one of skill in the art, the above list is not inclusive and may further include any commonly used user interface means.

The control section 130 can control the various functions of the device and can include a memory 131, a decoder 132, a cellular chip 133, a central processing unit (CPU) 134 and a digital communication unit 134. The memory 131 can include an operating system encoded with instructions which when operated by the CPU 134 enables the device 100 to communicate with external communication networks.

The cellular chip 133 can contain identification information pertaining to the device to which it is attached. This information can be specific to a user or the device itself and may further include information regarding the cellular network to which the user has an established account. This information can include unique identification information such as: a communication serial number, a static identification number (SIN) assigned by the cellular network or any other identification information necessary for securely communicating with and through a cellular network.

The digital communication unit 134 can convert voice data into digital data voice packets for transmission by the communication unit. As would be readily understood by one of skill in the art, the data packets can be created utilizing CDMA or any such data communication protocol employed within a particular broadband cellular network to which the device is connected or may be connected to.

In one embodiment, the Digital communication unit 135 may include a Digital converter 136 for performing a voice to data and data to voice conversion, a dialer interface 137 for generating an interface to be displayed on the display 121 of the device and an optional transmission selector 138. The transmission selector 138 can monitor the network signal strength at the cellular antenna 111 and the availability of WI-FI connections to the WI-FI antenna 112 in order to make a determination of which antenna to use. This determination may be based on, for example, user specified preferences, predetermined-minimum signal strength at the cellular antenna, or the availability of a preferred network to the WI-FI antenna 112.

The Digital communication unit 135 according to one embodiment may be a hard wired component within the device 100 and can thus be incorporated into a cellular device at the time of its creation, or may be externally connected (plugged in) to a device capable of cellular or WI-FI communication. Additionally, the Digital communication unit 135 may consist of program code that can be stored within the memory 131 of a cellular device or any device capable of cellular or WI-FI communication, and can be executable by the CPU 134. As such, the Digital communication unit can be a downloadable unit capable of imparting new functionality upon an existing device.

In operation, the cellular broadband device 100 can convert a voice communication into digital data voice packets for transmission across the broadband cellular network 190 or a wireless network 195. As would be understood to one of skill in the art, a digital data voice packet can be any type of audio signal or tone that has undergone transformation to a digital signal. To this end, according to one embodiment, voice data can be captured by the microphone 123 and sent to the Digital converter 136 to be converted into digital data voice packets. Upon generating the digital data voice packets, the CPU can transfer the voice packets to the cellular antenna 111 for transmission. Upon receiving the data, the cellular antenna can connect to the broadband cellular network 190 where it is assigned a network protocol address. As used herein, a network protocol address can be any known identification. address such as an IP address, for example. Upon successful connection to the broadband cellular network 190 the cellular antenna 111 can transmit the digital data voice packets to a server across a network (such as but not limited to the internet).

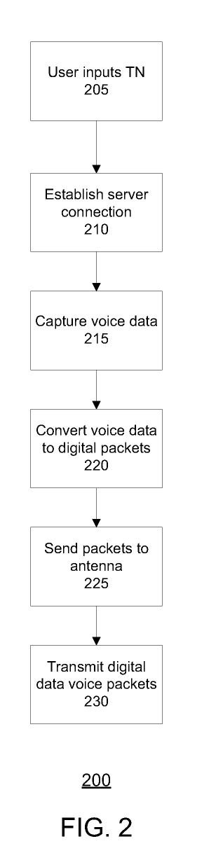

FIG. 2 is a flow chart illustrating a method 200 for converting audio/voice communication into digital data voice packets for transmission via a broadband cellular network according to one embodiment; Method 200 can be implemented by a cellular broadband device as described with reference to FIG. 1. Accordingly, method 200 can begin at step 205 where a user dials a telephone number into the interface generated by the dialer interface generator 137.

In step 210 the broadband cellular device establishes a connection with a gateway server via the cellular broadband network.

In step 215 voice data is captured by the microphone of the cellular broadband device.

In step 220, the voice data is sent to the Digital converter to be transformed into digital data voice packets.

In step 225, the CPU transfers the digital data voice packets (digitized voice data) to the cellular antenna 111 for transmission to the broadband cellular network 190. At step 230 the cellular antenna transmits the digital data voice packets to a server connected to a network (such as the Internet) via the broadband cellular network.

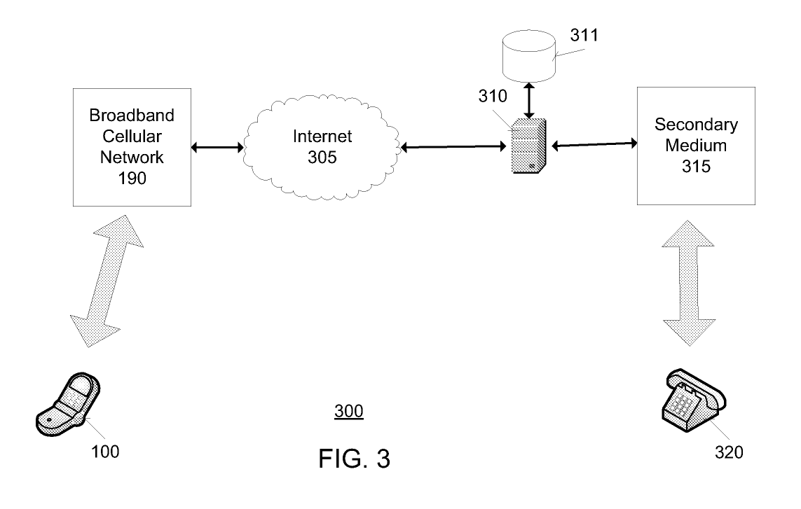

FIG. 3 illustrates a system 300 for transmitting voice data via a broadband cellular network according to one embodiment. As illustrated in FIG. 3, the cellular broadband device 100 can transmit a digitized audio signal (digital data voice packets) to the network 305 via the broadband cellular network 190. Once connected to the network, the device 100 can establish a connection with a gateway server 310 (such as, but not limited to a PBX system) which can convert the digital data voice packets for transmission across a secondary transmission medium 315 and on to the intended recipient 320.

A gateway server 310, according to one embodiment, can perform a conversion process upon a received digital data voice packet in order to allow the voice communication embodied within the packet to be communicated to a recipient, regardless of the network used by the recipient. Accordingly, if the intended recipient is utilizing a traditional telephone, the gateway server 310 can convert the digital data voice packet to an analogue signal which can be transmitted across the Public Switched Telephone Network (PSTN). Alternatively, if the intended recipient is a cellular phone, the server 310 can convert the digital data voice packet to a digital signal to be decoded by the cellular phone of the recipient. Finally, if the intended recipient is utilizing a digital system (such as a VoIP system, for example), the gateway server 310 can forward the received digital data voice packets to the digital communication system of the recipient.

As further illustrated in FIG. 3, a gateway server 310 according to one embodiment can include a database 311 configured to correlate a static identification number (SIN) with a user account. The user account can include, for instance, the 10-digit telephone number assigned to the device, the user name, address or any other user specific information typically provided by a cellular provider. Accordingly, when the server 310 receives a communication from a device 100 that includes a SIN, the server can retrieve the associated telephone number, convert the digitized voice signal to analogue, and transmit both via the PSTN. In an alternative embodiment, the communication can be stored within by the server for transmission at a later time. The database, as described above may be maintained and updated by the cellular provider to which the broadband cellular device is connected to, or may be a third party provider capable of offering digital communication services.

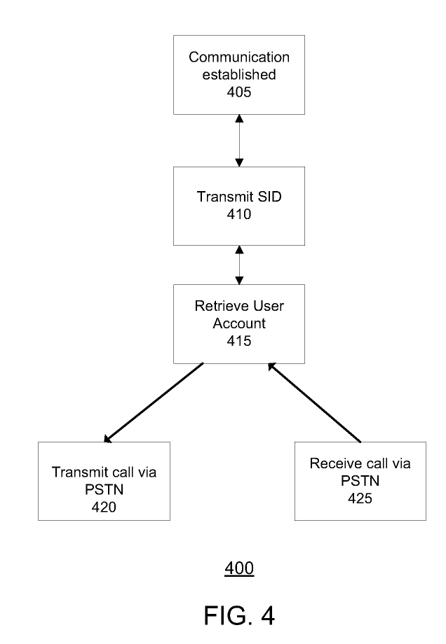

FIG. 4 illustrates a method for identifying a broadband cellular, device by a gateway server according to one embodiment. Method 400 can be implemented by a system as described with reference to FIG. 3. Accordingly, method 400 can begin at step 405 where a data connection has been established between the broadband cellular device 100 and the gateway server 310.

In step 410 the device transmits the static identification number assigned by the cellular provider to the server.

In step 415, the server associates the received static identification number with the broadband cellular device's assigned 10-digit telephone number.

In step 420 the server can route calls to the PSTN via the 10-digit telephone number, or in step 425 the server can route calls received from the PSTN to the device.

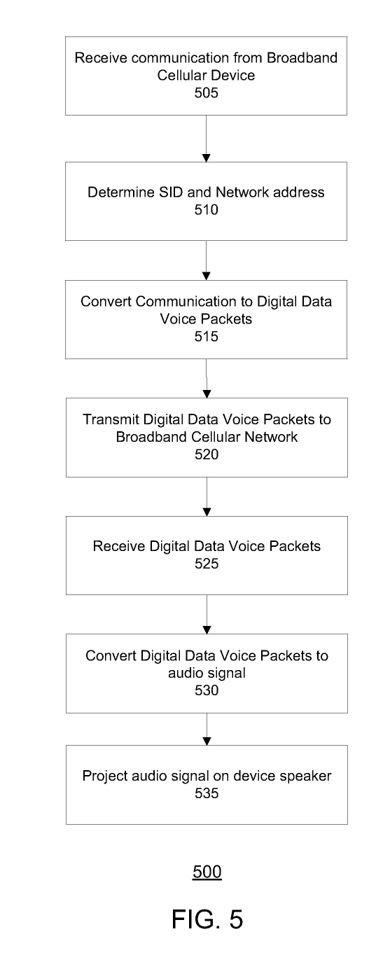

FIG. 5 illustrates a method for receiving a digital communication signal over a cellular broadband network according to one embodiment of the present invention. Method 500 can be implemented by a system as described with reference to FIG. 3. Accordingly, method 500 begins at step 505 where the gateway server 310 receives a communication intended for the 10 digit telephone number of the broadband cellular device 100.

In step 510, the server accesses database 311 to determine the SID and Network address associated with the 10 digit telephone. number.

In step 515 the server converts the received communication (analogue/digital if sender is using PSTN, or Cellular Network/data packets if using digital communication) into digital data voice packets.

In step 520 the server establishes communication with, and transmits the digital data voice packets to the broadband cellular network via a network (such as the internet).

In step 525, the cellular antenna 111 of the cellular broadband device 100 retrieves the digital data voice packets from the broadband cellular network.

In step 530 the digital data voice packets are converted to an audio signal via the Digital converter 136.

In step 535, the audio signal is sent to the speaker of the device.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention. However, this invention can be embodied in other forms without departing from the spirit or essential attributes thereof. Accordingly, reference should be made to the following claims, rather than to the foregoing specification, as indicating the scope of the invention.

What is claimed is:

1. A method for conducting digital communication over a network protocol via a cellular broadband device, said method comprising:
receiving a voice communication at the cellular broadband device;
converting, via a processor, the voice communication into a first transmission medium;
transmitting the first transmission medium to a server via a network;
converting, via a processor located at the server, said first transmission medium into a second transmission medium; and
transmitting the second transmission medium to a recipient.

2. The method of claim 1, wherein said first transmission medium is at least one digital data voice packet and said second transmission medium is one of a digital data voice packet, a digital signal, and an analogue signal.

3. The method of claim 1 wherein said transmitting the first transmission medium further comprises:
transmitting static identification information that includes at least one of a static identification number, a user name, a telephone number, and an address.

4. The method of claim 1 further comprising:
generating a dialer interface on a display of the device, wherein said dialer interface is configured to receive a telephone number for instructing the server on a location of the recipient.

5. The method of claim 1 wherein said transmitting the first transmission. medium is performed via a cellular antenna across a broadband cellular network.

6. The method of claim 1 wherein said transmitting the first transmission medium is performed via a WI-FI antenna across a wireless network connection.

7. A method for receiving digital communication over a network protocol at a cellular broadband device, said method comprising:
receiving a first transmission medium at a server, said communication including a telephone number associated with a broadband cellular device;
accessing a memory containing a static identifier associated with the received telephone number;
converting, via a processor, the first transmission medium into a second transmission medium;
transmitting said second transmission medium to the broadband cellular device identified by the static identifier;
receiving the second transmission medium at the broadband cellular device;
converting the received second transmission medium to voice data; and
presenting said voice data to a user.

8. The method of claim 7, wherein said first transmission medium is one of a digital data voice packet, a digital signal, and an analogue signal, and said second transmission medium is at least one digital data voice packet.

9. The method of claim 7 further comprising:
generating a dialer interface on a display of the cellular broadband device, wherein said dialer interface identifies a telephone number of a sender.

10. The method of claim 7 wherein said receiving the second transmission medium is performed via a cellular antenna connected to a broadband cellular network.

11. The method of claim 7 wherein said receiving the second transmission medium is performed via a WI-FI antenna connected to a wireless network connection.

12. A system for conducting digital communication over a network protocol via a cellular broadband device, said system comprising:
a broadband cellular device that includes
means for communicating with a user,
means for converting between a first and second transmission medium,
means for sending and receiving each of said first and second transmission medium across a network; and
a server that includes
means for receiving at least one of a first transmission medium and a second transmission medium,
means for accessing a memory containing a static identifier,
means for associating the static identifier with a telephone number of the broadband cellular device,
means for converting between the first and second transmission medium,
means for sending one of said first and second transmission medium to at least one of the networks and the broadband cellular device.

13. The system of claim 12, wherein said first and second transmission medium includes at least one of a digital data voice packet, a digital signal, an analogue signal and a voice communication.

14. The system of claim 12 wherein said broadband cellular device further includes a means for transmitting static identification information that includes at least one of a user name, a telephone number, and an address.

15. The method of claim 12, wherein said means for communicating with a user further includes generating a dialer interface on a display of the device, said dialer interface being configured to receive a telephone number for instructing the server on a location of a recipient.

16. The method of claim 12, wherein said means for communicating with a user further includes generating a dialer interface on a display of the cellular broadband device, said dialer interface identifying a telephone number of a sender.
